(19) United States
(12) Patent Application Publication
(10) Pub. No.: US 2025/0226474 A1
(43) Pub. Date: Jul. 10, 2025

(54) BATTERY COOLING DEVICE

(71) Applicant: TOYOTA JIDOSHA KABUSHIKI KAISHA, Toyota-shi Aichi (JP)

(72) Inventors: Masataka OGUSHI, Nisshin-shi Aichi (JP); Masaya NAKAMURA, Kariya-shi Aichi (JP)

(73) Assignee: TOYOTA JIDOSHA KABUSHIKI KAISHA, Toyota-shi Aichi (JP)

(21) Appl. No.: 19/010,342

(22) Filed: Jan. 6, 2025

(30) Foreign Application Priority Data
Jan. 9, 2024 (JP) 2024-001283

(51) Int. Cl. H01M 10/613; H01M 10/647; H01M 10/6556; H01M 10/6568

(52) U.S. Cl. CPC H01M 10/613; H01M 10/647; H01M 10/6556; H01M 10/6568

(57) ABSTRACT

A battery cooling device for cooling a battery module having battery cells, includes: first and second coolers and a distribution pipe for dividing and supplying cooling liquid to the first and second coolers. Further, the distribution pipe includes an upstream pipe, first and second supply pipes, and a flow rate adjusting valve for adjusting a flow rate of the cooling liquid supplied to the first cooler, and the flow rate adjusting valve opens and closes according to the flow rate of the cooling liquid flowing through the upstream pipe, and opens as the flow rate of the cooling liquid flowing through the upstream pipe increases.

### CROSS-REFERENCE TO RELATED APPLICATION(S)

The present application claims priority to and incorporates by reference the entire contents of Japanese Patent Application No. 2024-001283 filed in Japan on Jan. 9, 2024.

### BACKGROUND

The present disclosure relates to a battery cooling device.

Japanese Laid-open Patent Publication NO. 2018-18586 discloses the battery cooling apparatus for cooling the battery module that cools the entire battery cell by circulating pressurized refrigerant in the case accommodating the plurality of battery cells.

### SUMMARY

There is a need for providing a battery cooling device that can efficiently cool the battery cells according to the load.

According to an embodiment, a battery cooling device for cooling, by a cooling liquid, a battery module constituted by a plurality of battery cells, includes: a first cooler for cooling electrode terminals of the battery cells and bus bars connected to the electrode terminals with a cooling liquid; a second cooler for cooling the battery cells with coolant from a bottom side of the battery cells; and a distribution pipe for dividing cooling liquid and supplying the divided cooling liquid to the first cooler and the second cooler. Further, the distribution pipe includes an upstream pipe into which coolant flows, a first supply pipe, branched from the upstream pipe, communicating between the upstream pipe and the first cooler, and a second supply pipe, branched from the upstream pipe, communicating between the upstream pipe and the second cooler, an inside of the first supply pipe is equipped with a flow rate adjusting valve for adjusting a flow rate of the cooling liquid supplied to the first cooler, and the flow rate adjusting valve opens and closes according to the flow rate of the cooling liquid flowing through the upstream pipe, and opens as the flow rate of the cooling liquid flowing through the upstream pipe increases.

### BRIEF DESCRIPTION OF THE DRAWINGS

FIG. 1 is a schematic diagram showing a battery cooling apparatus according to an embodiment;

FIG. 2 is a diagram for explaining a bus bar cooler and a bottom cooler;

FIG. 3 is a diagram for explaining the distribution pipe;

FIG. 4 is a graph for explaining a flow rate of a cooling liquid and a supply flow rate to each cooler;

FIG. 5A is a diagram for explaining a case where the flow rate of the cooling liquid is small;

FIG. 5B is a diagram for explaining a case where the flow rate of the cooling liquid is medium;

FIG. 5C is a diagram for explaining a case where the flow rate of the cooling liquid is high;

FIG. 6A is a diagram for explaining a case where the flow rate of the cooling liquid is small for a distribution pipe in a modified example;

FIG. 6B is a diagram for explaining the case where the flow rate of the cooling liquid is moderate for the distribution pipe in the modified example; and

FIG. 6C is a diagram for explaining a case where the flow rate of the cooling liquid is high for the distribution pipe in the modified example.

### DETAILED DESCRIPTION

In order to suppress the shortening of the life of the battery cell due to heat generation, it is desirable to sufficiently cool the entire battery cell and avoid the battery cell from becoming a local high temperature state of the electrode at high load. However, although the configuration described in JP 2018-18586 can cool the entire battery cell by the refrigerant supplied in the case, it did not correspond to the local heat generation of the electrode.

Hereinafter, a battery cooling apparatus according to an embodiment of the present disclosure will be specifically described. Note that the present disclosure is not limited to the embodiments described below.

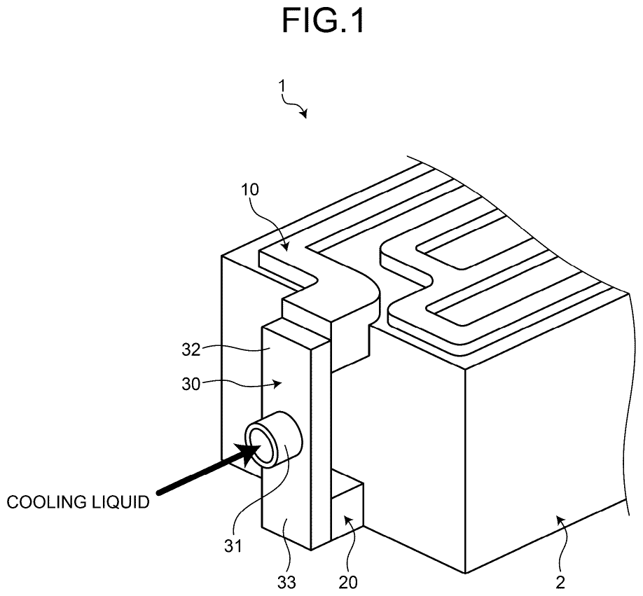

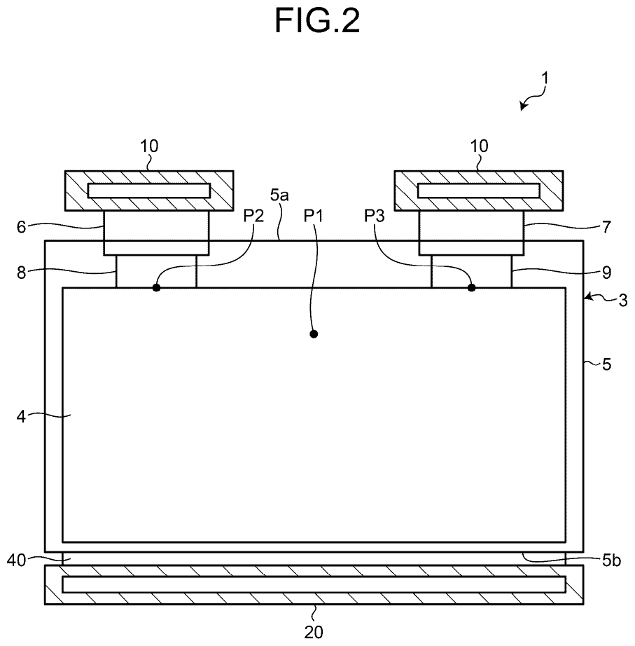

FIG. 1 is a schematic diagram illustrating a battery cooling apparatus according to an embodiment. A battery cooling device 1 is for cooling the battery module 2 by the cooling liquid. The battery cooling apparatus 1 includes a bus bar cooler 10, a bottom cooler 20, and a distribution pipe 30. In the battery module 2, as illustrated in FIG. 2, the battery cell 3 is cooled by the bus bar cooler 10 and the bottom cooler 20. The battery module 2 has a structure in which a plurality of battery cells 3 are stacked, the terminals of the battery cell 3 are electrically connected by a bus bar. The busbar cooler 10 is a first cooler and the bottom cooler 20 is a second cooler.

The bus bar cooler 10 is a cooler for cooling the bus bar and the electrode terminals of the battery cell 3. The bus bar cooler 10 is provided on the upper portion of the battery module 2, and has a cooling tube extending in the stacking direction of the battery cells 3. A cooling pipe of the bus bar cooler 10 is provided in accordance with the position where the electrode terminal of each battery cell 3 is disposed and the position where the bus bar is disposed. In the battery module 2 in which a plurality of battery cells 3 are stacked, each battery cell 3 is arranged so that the electrode terminals face upward, their electrode terminals are arranged in the stacking direction. The cooling tubes of the busbar cooler 10 extend in the stacking direction of the battery cells 3. The inside of the cooling pipe of the bus bar cooler 10 is a flow passage through which the cooling liquid flows.

As illustrated in FIG. 2, the bus bar cooler 10 is configured to receive heat from the electrode terminals of the battery cell 3. The battery cell 3 is a square cell, in which the case 5 for accommodating the electrode 4 is formed in a square shape. A positive terminal 6 and a negative terminal 7 are provided on the upper surface 5a of the case 5. The positive electrode terminal 6 is electrically connected to the electrode 4 via the positive electrode tab 8. The negative terminal 7 is electrically connected to the electrode 4 through the negative tab 9. The bus bar cooler 10 receives heat from the positive terminal 6, the negative terminal 7, and the bus bar, and cools the cell 3 from the upper surface 5a. The bottom cooler 20 is provided on the bottom 5b of the case 5.

The bottom cooler 20 is a cooler for cooling the battery cell 3 from the bottom 5b of the battery cell 3. The bottom cooler 20 is provided in the lower portion of the battery module 2, extending in the stacking direction of the battery cells 3 in accordance with the width of the battery cells 3. Inside the bottom cooler 20 is a flow path through which the cooling liquid flows in the stacking direction. As illustrated in FIG. 2, the bottom cooler 20 is connected to the bottom 5b of the cell 3 through the heat transfer member 40 in a heat transferable manner. The bottom cooler 20 receives heat from the bottom 5b of the case 5 of the battery cell 3 and cools the battery cell 3 from the bottom 5b.

The distribution pipe 30 is a pipe for diverting the cooling liquid to the bus bar cooler 10 and the bottom cooler 20. The distribution pipe 30 has an upstream pipe 31, a first supply pipe 32 for supplying the cooling liquid to the bus bar cooler 10, and a second supply pipe 33 for supplying the cooling liquid to the bottom surface cooler 20. The distribution pipe 30 is formed in a structure in which the first supply pipe 32 and the second supply pipe 33 is branched from the upstream pipe 31.

The upstream pipe 31 forms a flow path through which the cooling liquid for cooling the battery module 2 flows. Coolant flowing through the upstream pipe 31 is diverted to the first supply pipe 32 and the second supply pipe 33.

The first supply pipe 32 is a first branch pipe branched at the downstream side of the upstream pipe 31 is connected to the inlet of the bus bar cooler 10. The first supply pipe 32 communicates the upstream pipe 31 and the busbar cooler 10. The inside of the first supply pipe 32 forms a supply flow passage in which the cooling liquid supplied to the bus bar cooler 10 flows.

The second supply pipe 33 is a second branch pipe branched at the downstream side of the upstream pipe 31 is connected to the inlet of the bottom cooler 20. The second supply pipe 33 communicates the upstream pipe 31 and the bottom cooler 20. Inside the second supply pipe 33 forms a supply channel through which the cooling liquid supplied to the bottom cooler 20 flows.

The battery cooling device 1 configured in this way is applied to a battery pack mounted on an electric vehicle. In the battery pack for an electric vehicle, the base of the current collecting tab of the electrode 4 becomes locally high temperature by heat generation of the battery cell 3 and heat generation of the bus bar connecting the terminals of the battery cell 3 during high load running. At the time of high loading, the root P2 of the positive electrode tab 8 and the root P3 of the negative electrode tab 9 become a high temperature condition, and the site P1 of the electrode 4 becomes the maximum temperature point. The battery cell 3 has a concern that life is shortened when the high-temperature state, there is a possibility that cannot be controllably high-load running. Therefore, at the time of high load, by cooling the bus bar by the bus bar cooler 10, it is necessary to suppress the occurrence of local high temperature of the battery cell 3. During the medium load from the time of low load, since the need to sufficiently cool the entire battery cell 3, the bottom cooler 20 is provided on the bottom 5b of the battery cell 3. However, when the bus bar cooling by the bus bar cooler 10 is performed even during running at a low to medium load, the flow rate of the cooling liquid supplied to the bottom surface cooler 20 is reduced because the cooling liquid is supplied to the bus bar cooler 10, and thus the effect of cooling the entire battery cell 3 is lowered. Therefore, as bus bar cooling by the bus bar cooler 10 is performed only at the time of high load in the battery cooling apparatus 1, the flow rate adjusting valve 50 for opening and closing in accordance with the load is provided inside the first supply pipe 32.

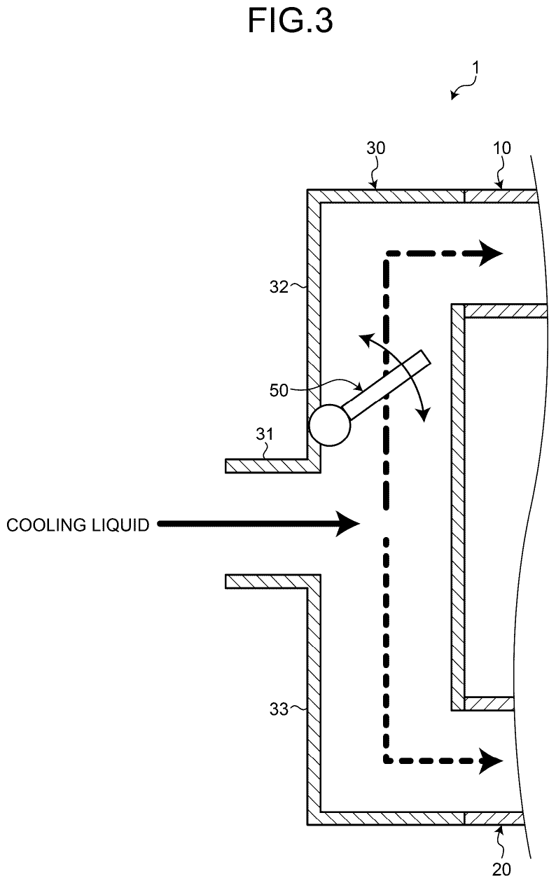

As illustrated in FIG. 3, a flow regulating valve 50 is provided inside the first supply pipe 32, a valve for varying the flow path cross-sectional area of the supply flow path of the first supply pipe 32. The flow adjustment valve 50 has a rotary structure which opens by pushing the downstream side by the cooling liquid flowing from the upstream pipe 31 to the first supply pipe 32 in the flow path of the first supply pipe 32.

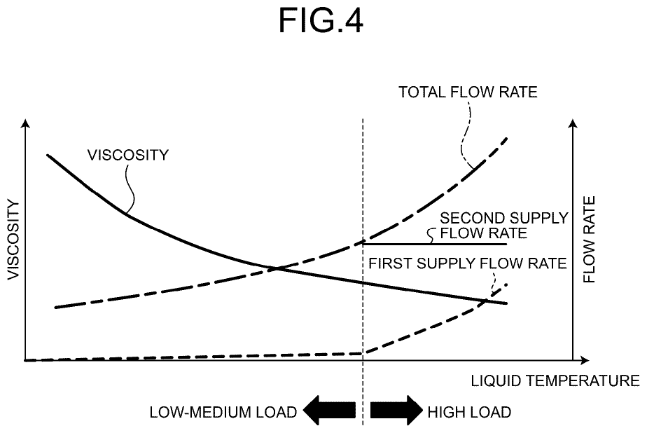

The flow rate adjusting valve 50 is opened and closed according to the flow rate of the cooling liquid flowing through the upstream pipe 31, and opens as the flow rate of the cooling liquid flowing through the upstream pipe 31 increases. That is, the flow rate adjusting valve 50 functions as a pressure loss adjusting mechanism operated by the pressure difference of the cooling liquid in the distribution pipe 30, and opens and closes according to the load. The temperature of the coolant increases as the load increases. As illustrated in FIG. 4, the viscosity of the cooling liquid decreases due to the temperature of the cooling liquid rising. As the viscosity of the cooling liquid decreases, the flow velocity of the cooling liquid increases and the total flow rate of the cooling liquid increases. In the battery cooling device 1, it is configured to feed the cooling liquid from the distribution pipe 30 to the bus bar cooler 10 by opening the flow rate adjusting valve 50 by increasing the total flow rate of the cooling liquid. That is, the flow rate adjusting valve 50 is configured to open by the flow rate of the upstream pipe 31 is increased.

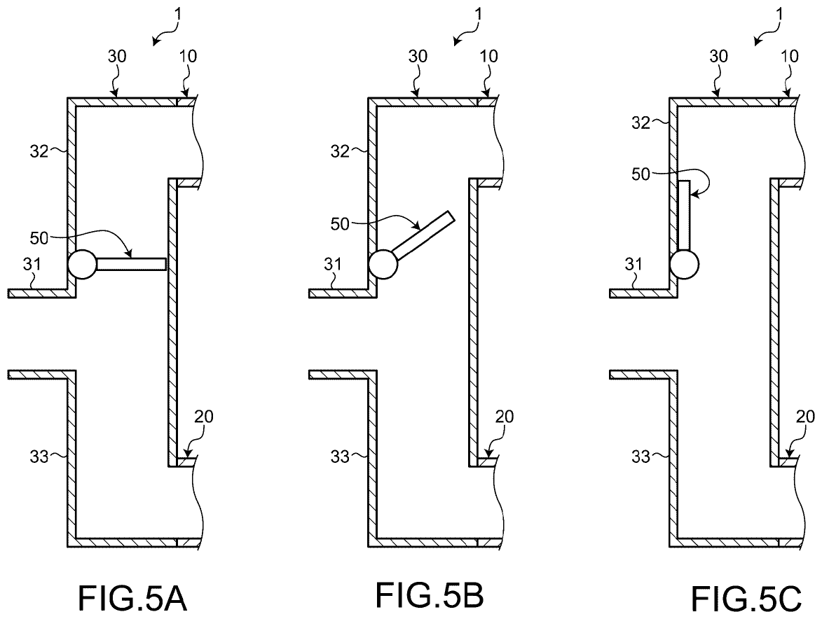

As illustrated in FIG. 5A, when the total flow rate of the cooling liquid is small, the flow rate adjusting valve 50 does not open, and no coolant flows through the busbar cooler 10. Since the total flow rate of the cooling liquid is small in the case of low to medium loads as shown in FIG. 4, the flow rate adjusting valve 50 closes. In this case, all the cooling liquid flowing through the upstream pipe 31 flows into the second supply pipe 33 is supplied to the bottom cooler 20. Therefore, it is possible to suppress the cooling liquid from being supplied to the bus bar cooler 10 at the time of low to medium load, and the entire battery cell 3 can be cooled down by the bottom surface cooler 20. Thus, it is possible to cool the battery cell 3 by using the cooling liquid efficiently.

As illustrated in FIG. 5B, when the total flow rate of the cooling liquid increases from the state illustrated in FIG. 5A, the cooling liquid pushes up the flow rate adjusting valve 50 to the downstream side, so that the flow rate adjusting valve 50 opens. The state shown in FIG. 5B is a state in which a portion of the first supply flow path is opened. Therefore, a part of the cooling liquid flowing through the upstream pipe 31 is supplied to the bus bar cooler 10. In this case, the battery cell 3 is cooled around the bottom cooler 20.

As illustrated in FIG. 5C, when the total flow rate of the cooling liquid further increases from the state illustrated in FIG. 5B, the flow rate adjusting valve 50 is completely opened. As illustrated in FIG. 4, when a high load is applied, the total flow rate of the cooling liquid increases, and the flow rate adjusting valve 50 opens due to this increase in flow rate, and the first supply flow rate, which is the flow rate of the cooling liquid supplied to the bus bar cooler 10, increases. When the high load becomes and the flow rate adjusting valve 50 is fully opened, the first supply flow rate increases in accordance with an increase in the total flow rate of the cooling liquid, and the second supply flow rate, which is the flow rate of the cooling liquid supplied to the bottom surface cooler 20, becomes substantially constant. The second supply flow rate is the same as the total flow rate of the cooling liquid in the range from the low load to the medium load in which the flow adjustment valve 50 is closed.

In a state where the flow rate adjusting valve 50 is opened at the time of high load, the cooling performance according to the first supply flow rate and the second supply flow rate can be exhibited using both the bus bar cooler 10 and the bottom cooler 20. As illustrated in FIG. 2, when the site P1 of the electrode 4 becomes the maximum temperature point, heat of the site P1 is transferred to the bus bar cooler 10 from the positive electrode terminal 6 side through the root P2 of the positive electrode tab 8 by conducting to the top of the electrode 4, and heat of the site P1 is transferred to the bus bar cooler 10 from the negative electrode terminal 7 side through the root P3 of the negative electrode tab 9 by conducting to the top of the electrode 4. In addition, heat of the site P1 is conducted below the electrodes 4 and is transferred to the bottom cooler 20 through the bottom 5b. Thus, it is possible to suppress the local high temperature of the electrode 4 by cooling from the bus bar at the time of high load.

As described above, according to the embodiment, it is possible to switch the diversion of the cooling liquid according to the load by the distribution pipe 30 in which the flow adjustment valve 50 is provided. Since the cooling liquid is supplied to the bus bar cooler 10 from the distribution pipe 30 only at the time of high load, by cooling the electrode terminals of the bus bar and the battery cell 3 by the bus bar cooler 10 at the time of high load, it is possible to suppress the local high temperature of the electrode 4. In the low to medium load region where the bus bar cooling is not necessary, the cooling liquid is supplied from the distribution pipe 30 to the bottom surface cooler 20, but the supply flow rate from the distribution pipe 30 to the bus bar cooler 10 can be throttled, so that the cooling efficiency of the entire battery cell 3 can be suppressed to be lowered.

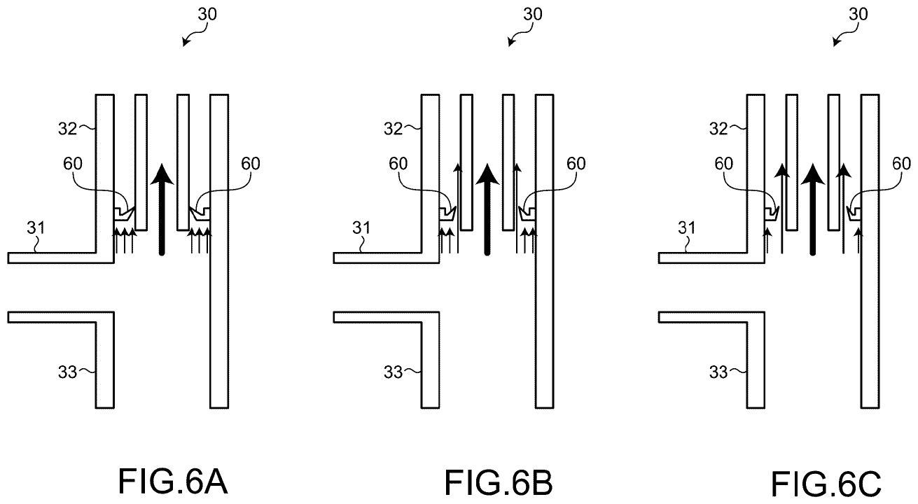

The valve provided inside the first supply pipe 32 is not limited to a rotary structure such as a flow regulating valve 50. For example, as illustrated in FIGS. 6A to 6C, it may be provided a lip-sealed valve 60 inside the first supply pipe 32. As illustrated in FIG. 6A, when the total flow rate of the cooling liquid is small, the valve 60 is closed, and the battery cell 3 can be cooled down by the bottom cooler 20. As illustrated in FIG. 6B, when the total flow rate of the cooling liquid is moderate, the valve 60 opens, and the battery cell 3 can be cooled down around the bottom cooler 20. As illustrated in FIG. 6C, when the total amount of the cooling liquid is large, the valve 60 is in the open state, it is possible to cool the electrode terminals of the bus bar and the battery cell 3 by the bus bar cooler 10.

In the present disclosure, since the flow rate of the cooling liquid increases with an increase in the temperature of the cooling liquid when the load is high, the flow rate adjusting valve provided in the first supply pipe opens and closes according to the flow rate of the cooling liquid, so that the battery cell can be efficiently cooled according to the load.

What is claimed is:

1. A battery cooling device for cooling, by a cooling liquid, a battery module constituted by a plurality of battery cells, the battery cooling device comprising:
a first cooler for cooling electrode terminals of the battery cells and bus bars connected to the electrode terminals with a cooling liquid;
a second cooler for cooling the battery cells with coolant from a bottom side of the battery cells; and
a distribution pipe for dividing cooling liquid and supplying the divided cooling liquid to the first cooler and the second cooler, wherein
the distribution pipe includes
an upstream pipe into which coolant flows,
a first supply pipe, branched from the upstream pipe, communicating between the upstream pipe and the first cooler, and
a second supply pipe, branched from the upstream pipe, communicating between the upstream pipe and the second cooler,
an inside of the first supply pipe is equipped with a flow rate adjusting valve for adjusting a flow rate of the cooling liquid supplied to the first cooler, and
the flow rate adjusting valve opens and closes according to the flow rate of the cooling liquid flowing through the upstream pipe, and opens as the flow rate of the cooling liquid flowing through the upstream pipe increases.

2. The battery cooling device according to claim 1, wherein
the flow rate adjusting valve is an open and close valve, which operates so as to be pushed towards a downstream side in a flowing path of the first supply pipe as the flow rate of the cooling liquid flowing through the upstream pipe increases.
